(19) United States
(12) Patent Application Publication
(10) Pub. No.: US 2004/0021295 A1
(43) Pub. Date: Feb. 5, 2004

(54) Vehicle hitch assembly

(75) Inventor: David L. Westerdale, Monroe, MI (US)

Correspondence Address: BROOKS KUSHMAN P.C., 1000 TOWN CENTER, TWENTY-SECOND FLOOR, SOUTHFIELD, MI, 48075, US

(73) Assignee: Midway Products Group, Inc., Monroe, MI

(21) Appl. No.: 10/630,533

(22) Filed: Jul. 30, 2003

Related U.S. Application Data
(63) Continuation-in-part of application No. 10/131,066, filed on Apr. 24, 2002.

(51) Int. Cl. B60D 1/00

(52) U.S. Cl. 280/495

(57) ABSTRACT

A vehicle hitch assembly (10) includes a stamped sheet metal cross tube (16) of an elongated shape with a central hitch support section (18) and lateral ends (20) mounted on the vehicle. A pair of stamped sheet metal members (22) of the sheet metal cross tube (16) each have intermediate portions (24) that project away from each other as well as having spaced peripheral flanges (26, 28) that are engaged with and secured to the peripheral flanges of the other stamped sheet metal member. The central hitch support section (18) of the stamped sheet metal cross tube (16) has a hitch ball support (32) for mounting a ball hitch on the hitch assembly.

### CROSS-REFERENCE TO RELATED APPLICATIONS

This application is a continuation-in-part of pending application Ser. No. 10/131,066, filed on Apr. 24, 2002 by David L. Westerdale under the title VEHICLE HITCH ASSEMBLY.

### BACKGROUND OF THE INVENTION

1. Field of the Invention

This invention relates to a vehicle hitch assembly for mounting on a vehicle to support a hitch ball used in towing behind the vehicle.

2. Background Art

Vehicle hitch assemblies are utilized by mounting thereof on an associated vehicle to support a hitch ball that is utilized to tow a trailer or other type of wheeled follower behind the vehicle. One type of such hitch assemblies includes a laterally extending cross tube that is formed by rolling thereof into a square or round cross section and by then welding a seam along its length with opposite ends of the cross tube supported on the vehicle by suitable connectors. Such laterally extending cross tubes can have a central portion with a hitch ball support that is permanently attached thereto and having a hitch ball secured by a threaded connection. The central hitch ball support can also be embodied as a hitch receiver tube as disclosed by U.S. Pat. No. 5,853,187 Maier and U.S. Pat. No. 6,173,984 Kay, and a tow bar with a hitch ball thereon is then inserted into the receiver tube and secured by a suitable retainer pin.

Other vehicle structures noted during an investigation conducted in connection with this invention are disclosed by U.S. Pat. No. 5,785,367 Baumann et al.; U.S. Pat. No. 5,803,517 Shibuya; U.S. Pat. No. 6,192,584 Gundlach et al.; and U.S. Pat. No. 6,299,226 Kröning et al. Further prior art cited in the prosecution of the parent application hereof include: U.S. Pat. No. 2,136,122 Amdale; U.S. Pat. No. 3,578,358 Reynolds; U.S. Pat. No. 3,768,837 Reese; U.S. Pat. No. 6,270,600 Wycech; U.S. Pat. No. 6,316,074 Kaiser et al.; U.S. Pat. No. 6,402,179 Morris et al.; United States published application 2002/0047249 McCoy et al.; and European patent document No. 491,214 Laltlomaki.

### SUMMARY OF THE INVENTION

An object of the present invention is to provide an improved vehicle hitch assembly.

In carrying out the above object, a vehicle hitch assembly for mounting on a vehicle in accordance with the invention is constructed to include a stamped sheet metal cross tube having an elongated shape that extends laterally with respect to the associated vehicle. The stamped sheet metal cross tube includes a central hitch support section as well as including a pair of laterally extending ends that project laterally away from the central hitch support section for mounting on the vehicle. The stamped sheet metal cross tube is constructed to include a pair of stamped sheet metal members of the same construction as each other. This pair of stamped sheet metal members each has an intermediate portion that projects away from the other stamped sheet metal member so the stamped sheet metal cross tube has a hollow construction. The pair of stamped sheet metal members each have spaced peripheral flanges that are engaged with and secured to the peripheral flanges of the other stamped sheet metal member. The central hitch support section of the stamped sheet metal cross tube has a hitch ball support for mounting a hitch ball on the hitch assembly.

The vehicle hitch assembly also includes a pair of vehicle supports that respectively support the pair of laterally extending ends of the stamped sheet metal cross tube on the vehicle. More specifically, the pair of vehicle supports have openings that respectively receive the pair of laterally extending ends of the stamped sheet metal cross tube, and welds secure the laterally extending ends of the stamped sheet metal cross tube to the vehicle supports.

In one embodiment, the central hitch support section of the stamped sheet metal cross tube has a downwardly projecting shape. This downwardly projecting shape of the central hitch support section of the stamped sheet metal cross tube is disclosed as being triangular.

The one embodiment has the central hitch support section of the stamped sheet metal cross tube provided with a downwardly opening formation, and the hitch ball support is embodied by a hitch receiver tube received within the downwardly opening formation of the central hitch support section and secured thereto by welds.

The one embodiment also has the spaced peripheral flanges of the pair of stamped sheet metal members of the stamped sheet metal cross tube constructed to include upper and lower peripheral flanges between which the intermediate portions of the stamped sheet metal members extend respectively projecting forwardly and rearwardly with respect to the vehicle away from each other. This pair of stamped sheet metal members are thus upper and lower members. The upper peripheral flanges have straight shapes extending continuously between the ends of the stamped sheet metal cross tube, while the lower peripheral flanges extend along the ends of the stamped sheet metal cross tube and have inner portions that extend downwardly at the central hitch support section and have lower ends that are spaced from each other. This central hitch support section as previously mentioned projects downwardly and has a downwardly opening formation located between the lower ends of the inner portions of the lower peripheral flanges, and the hitch ball support is embodied by a hitch receiver tube that is received within the downwardly opening formation of the central hitch support section and is secured thereto by welds.

The central hitch support section of the one embodiment includes an auxiliary chain connector which has a connection plate welded to the central hitch support section. More specifically, the connection plate has a horizontal portion welded to both the central hitch support section and to the hitch receiver tube, and the connection plate also has an inclined portion extending downwardly to the rear from the horizontal portion and having a pair of auxiliary chain connection openings.

In another embodiment, the spaced peripheral flanges of the pair of stamped sheet metal members of the stamped sheet metal cross tube include front and rear peripheral flanges between which the intermediate portions of the stamped sheet metal members extend respectively projecting upwardly and downwardly away from each other. Thus, in this embodiment the pair of stamped sheet metal members are upper and lower members whose intermediate portions project vertically. The front and rear peripheral flanges of this embodiment have straight shapes extending between the ends of the stamped sheet metal cross tube and the central hitch support section. The central hitch support section of the stamped sheet metal cross tube projects rearwardly to provide the hitch ball support which is embodied as a hitch receiver tube. The rear flanges of the pair of stamped sheet metal members of this embodiment have inner ends at the central hitch support section, and an auxiliary chain connector includes connector holes in the inner ends of the rear flanges.

### BRIEF DESCRIPTION OF THE DRAWINGS

FIG. 1 is a perspective view of one embodiment of a vehicle hitch assembly constructed in accordance with the present invention for mounting on a vehicle so as to be used in towing a trailer behind the vehicle.

FIG. 2 is a partially disassembled perspective view of the hitch assembly of FIG. 1 to further illustrate its construction.

FIG. 3 is a side view of the hitch assembly taken along the direction of line 2-2 in FIG. 3 to further illustrate the manner in which the hitch assembly is mounted on an associated vehicle.

FIG. 4 is a partial enlarged view of FIG. 1 illustrating the construction of a central hitch support section of the assembly which includes a hitch receiver tube and an auxiliary chain connector.

FIG. 5 is a partial side view of the central hitch support section taken along the direction of line 5-5 in FIG. 4 to further illustrate the construction involved.

FIG. 6 is a perspective view similar to FIG. 1 of another embodiment of the vehicle hitch assembly constructed in accordance with the present invention.

FIG. 7 is a top plan view of the vehicle hitch assembly taken along the direction of line 7-7 in FIG. 6.

FIG. 8 is a side view of the hitch assembly taken along the direction of line 8-8 in FIG. 7 to further illustrate the manner in which the hitch assembly is mounted on an associated vehicle.

### DETAILED DESCRIPTION OF THE PREFERRED EMBODIMENT

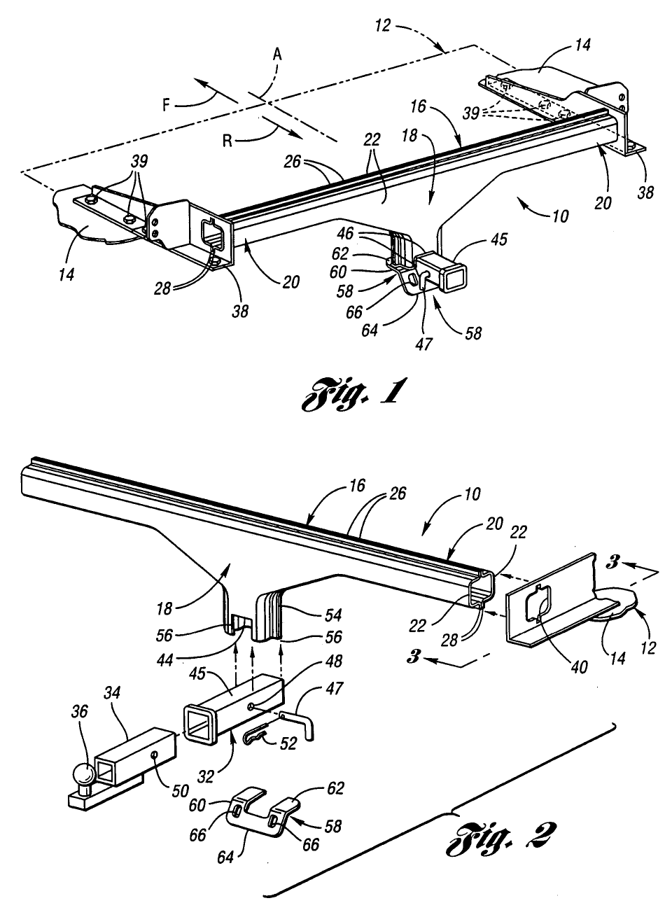

As illustrated in FIGS. 1-5 of the drawings, one embodiment of a vehicle hitch assembly constructed in accordance with the present invention is generally indicated by 10 and is constructed to be mounted on a partially schematically indicted vehicle 12 having a longitudinal axis A with a forward direction illustrated by arrow F and a rearward direction illustrated by arrow R. More specifically, the hitch assembly 10 is mounted as is hereinafter more fully described on a pair of laterally spaced rearward portions 14 of the vehicle 12 in order to permit towing of a trailer or other wheeled vehicle.

As shown in FIGS. 1 and 2, the hitch assembly 10 includes a stamped sheet metal cross tube 16 having an elongated shape that extends laterally with respect to the longitudinal axis of the associated vehicle 12 and has a central hitch support section 18 as well as a pair of laterally extending ends 20 that project laterally away from the central hitch support section for mounting on the vehicle.

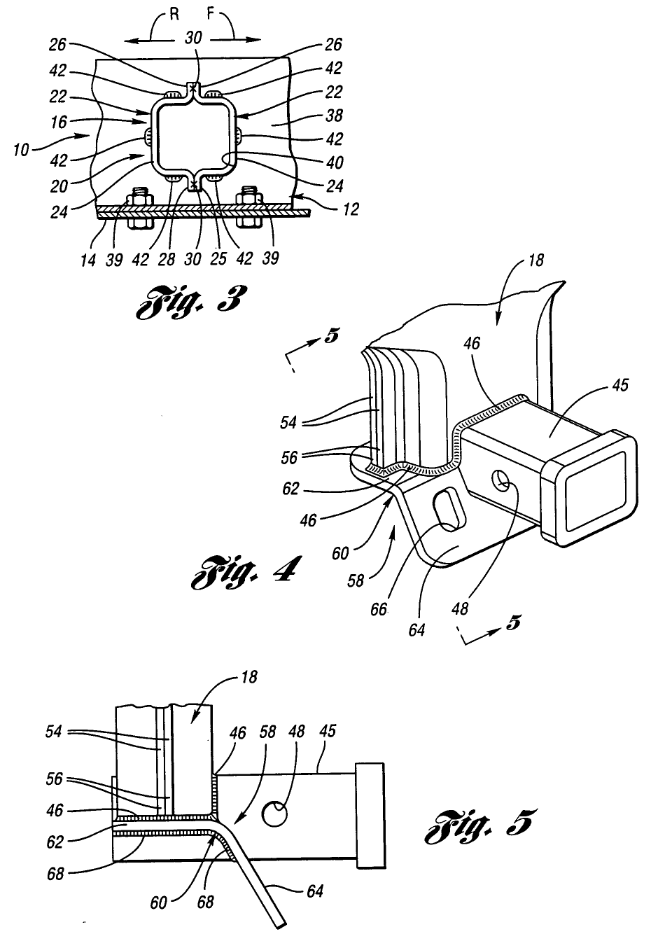

With additional reference to FIG. 3 as well as to FIGS. 1 and 2, the stamped sheet metal cross tube 16 includes a pair of stamped sheet metal members 22 that have the same construction as each other such that they can be stamped from the same set of dies as each other and thereby reduce tooling cost. As shown specifically in FIG. 3, the pair of stamped sheet metal members 22 are front and rear members and each has an intermediate portion 24 that projects away from the other stamped sheet metal member so the stamped sheet metal cross tube 16 has a hollow construction. Thus, the intermediate portion 24 of the front and rear members project horizontally away from each other respectively in forward and rearward directions. The pair of stamped sheet metal members 22 also each has spaced peripheral flanges 26 and 28 that are respectively engaged with and secured to the peripheral flanges of the other stamped sheet metal member with the securement preferably provided by welds 30. It should be appreciated that after stamping of the members 22 by the same tool set in a manner that reduces cost, each member may be further machined or formed as necessary, such as to provide drain holes, etc., without the same subsequent operation on the other member whose position does not require further modification.

As shown in FIGS. 1 and 2, the central hitch support section 18 of the stamped sheet metal cross tube 16 has a hitch ball support 32 for mounting a tow bar 34 having a hitch ball 36 to which a trailer tongue or other trailering tongue is attachable in a conventional manner.

As illustrated in all of the drawings, a pair of vehicle supports 38 support the laterally extending ends 20 of the stamped sheet metal cross tube 16 on the vehicle 12 at its laterally spaced rearward portions 14 with suitable fasteners 39, such as nut and bolt connections, rivets, etc., utilized to provide securement. As best shown in FIG. 2, the supports 38 have associated openings 40 of the same shape as the cross tube ends 20 so as to receive and support the cross tube ends as well as being secured thereto by welds 42 illustrated in FIG. 3.

As shown in FIGS. 1 and 2, the central hitch support section 18 of the stamped sheet metal cross tube has a downwardly projecting shape that is preferably triangular as shown. Furthermore, the central hitch support section 18 of the stamped sheet metal cross tube 16 has a downwardly opening formation 44 that is provided in each of the stamped sheet metal members 22. The hitch ball support 32 is embodied by a hitch receiver tube 45 that is received within the downwardly opening formation 44 of the central hitch support section 18 and is secured thereto by welds 46 shown in FIG. 1. This hitch receiver tube 45 receives the tow bar 34 with the hitch ball 36 mounted thereon, and an L-shaped retainer pin 47 is inserted through a hole 48 in the receiver tube 45 and a hole 50 in the tow bar 34 to retain the tow bar in cooperation with a retention clip 52. While it is also possible for the hitch assembly to be utilized with other types of hitch ball supports such as ones that are not removable, the illustrated construction is preferred in that it allows the hitch ball to be conveniently removed when not required for use with the vehicle without any rearward projection from the vehicle.

As best illustrated in FIG. 3, the pair of stamped sheet metal members 22 of the stamped sheet metal cross tube 16 include upper peripheral flanges 26 and lower peripheral flanges 28 between which the intermediate portions 24 extend respectively projecting in a horizontal direction forwardly and rearwardly with respect to the vehicle away from each other in order to provide the hollow construction of the stamped sheet metal cross tube 16. The upper peripheral flanges 26 as shown in FIGS. 1 and 2 have straight shapes extending continuously between the ends 20 of the stamped sheet metal cross tube 16, while the lower peripheral flanges 28 extend along the ends 20 of the stamped sheet metal cross tube 16 and include inner portions 54 that project downwardly at the central hitch support section 18 and have lower ends 56 that are spaced from each. The downwardly opening formation 44 of the central hitch support section 18 is located between the lower ends 56 of the inner portions 54 of the lower flanges 28 to receive the hitch receiver tube 45 that embodies the hitch ball support 32 as previously described with securement being provided by the welds 46 previously mentioned in connection with FIG. 1.

As illustrated in FIGS. 1, 2, 4 and 5, the downwardly projecting central hitch support section 18 includes an auxiliary chain connector 58 that is utilized to connect auxiliary chains in the case of hitch breakage or malfunction. More specifically, the auxiliary chain connector 58 includes a connection plate 60 welded to the central hitch support section 18 by the welds 46 that are also utilized to weld the hitch receiver tube 45 to the central hitch support section. The welds 46 are located above the connection plate 60. The construction of the connection plate 60 includes a horizontal portion 62 and an inclined portion 64 extending downwardly to the rear from the horizontal portion. This inclined portion 64 as shown in FIG. 2 includes a pair of auxiliary chain connection openings 66 for use in connecting the auxiliary chains. Furthermore, additional welds 68 located below the connection plate 60 secure its horizontal portion 62 and inclined portion 64 to the side of the hitch receiver tube 44 as illustrated in FIG. 5.

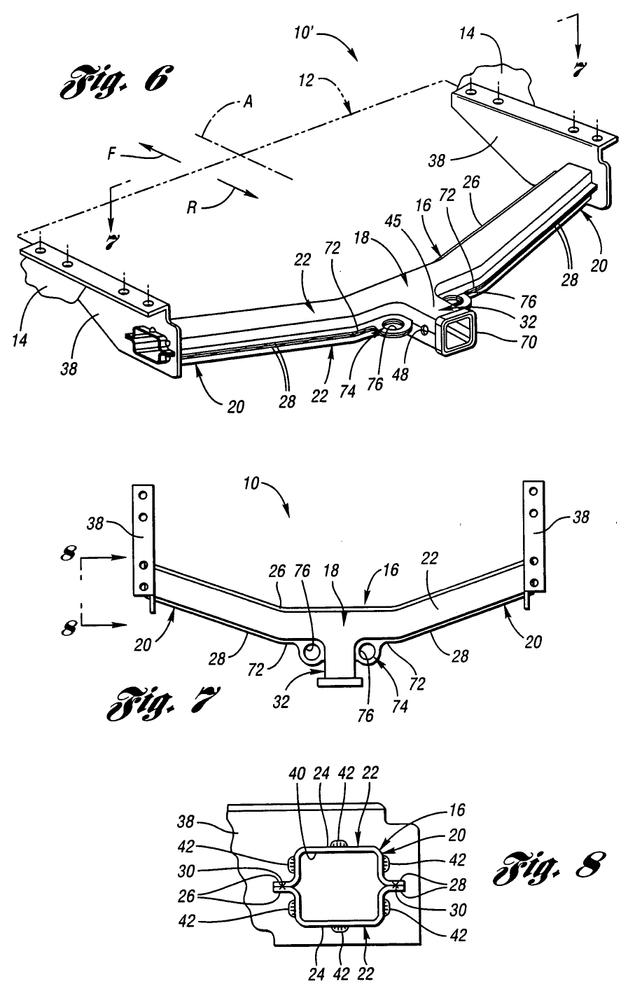

With reference to FIGS. 6-8, another embodiment of the vehicle hitch assembly is generally indicated by 10′ and has a similar construction to the previously described embodiment of FIGS. 1-5 such that like reference numerals are utilized with like components thereof and much of the previous description is applicable and thus will not be repeated.

In the embodiment of the vehicle hitch assembly 10′ shown in FIGS. 6-8, the pair of stamped sheet metal members 22 of the same construction are upper and lower members as opposed to front and rear members as disclosed with the embodiment of FIGS. 1-5. Furthermore, the pair of spaced peripheral flanges 26 and 28 of each stamped sheet metal member 22 are front and rear flanges as opposed to upper and lower flanges as with the previously described embodiment. These front and rear flanges 26 and 28 have straight shapes extending between the ends 20 of the stamped sheet metal cross tube 16 and the central hitch support section 18. The central hitch support section 18 extends rearwardly in this embodiment and the stamped sheet metal members are formed to embody the hitch receiver tube 45 that receives an unshown tow bar in the same manner previously described with the earlier embodiment. At its distal rear end, the hitch receiver tube is received within a reinforcement ring 70 that is welded to the tube and strengthens the assembly.

The rear flanges 28 of the upper and lower stamped sheet metal members 22 have inner ends 72 that are located at the central hitch support section 18. An auxiliary chain connector 74 is provided by holes 76 in the inner ends 72 of the rear flanges 28 so as to permit connection of auxiliary chains of the towed trailer, etc.

The stamped sheet metal construction of each embodiment of the hitch assembly 10′ allows it to be made from sheet metal stock that is only about two thirds the thickness of that used with the conventional rolled and welded tube construction, about 4 mm. thickness versus about 6.6 mm. thickness, such that substantial weight savings result in addition to the cost saving advantage.

While the preferred embodiment of the invention has been described in detail, those familiar with the art to which this invention relates will recognize various alternative designs and embodiments as defined by the following claims.

What is claimed is:

1. A vehicle hitch assembly for mounting on a vehicle, comprising:
a stamped sheet metal cross tube having an elongated shape that extends laterally with respect to the associated vehicle, and the stamped sheet metal cross tube including a central hitch support section as well as including a pair of laterally extending ends that project laterally away from the central hitch support section for mounting on the vehicle;
the stamped sheet metal cross tube including a pair of stamped sheet metal members of the same construction as each other, said pair of stamped sheet metal members each having an intermediate portion that projects away from the other stamped sheet metal member so the stamped sheet metal cross tube has a hollow construction, and the pair of stamped sheet metal members each having spaced peripheral flanges that are engaged with and secured to the peripheral flanges of the other stamped sheet metal member; and
the central hitch support section of the stamped sheet metal cross tube having a hitch ball support for mounting a hitch ball on the hitch assembly.

2. A vehicle hitch assembly as in claim 1 further including a pair of vehicle supports that respectively support the pair of laterally extending ends of the stamped sheet metal cross tube on the vehicle.

3. A vehicle hitch assembly as in claim 2 wherein the pair of vehicle supports have openings that respectively receive the pair of laterally extending ends of the stamped sheet metal cross tube, and further including welds that secure the laterally extending ends of the stamped sheet metal cross tube to the vehicle supports.

4. A vehicle hitch assembly as in claim 1 central hitch support section of the stamped sheet metal cross tube has a downwardly projecting shape.

5. A vehicle hitch assembly as in claim 4 wherein the downwardly projecting shape of the central hitch support section is triangular.

6. A vehicle hitch assembly as in claim 1 wherein the central hitch support section of the stamped sheet metal cross tube has a downwardly opening formation, and the hitch ball support being embodied by a hitch receiver tube received within the downwardly opening formation of the central hitch support section and secured thereto by welds.

7. A vehicle hitch assembly as in claim 1 wherein the spaced peripheral flanges of the pair of stamped sheet metal members of the stamped sheet metal cross tube include upper and lower peripheral flanges between which the intermediate portions of the stamped sheet metal members extend respectively projecting forwardly and rearwardly with respect to the vehicle away from each other.

8. A vehicle hitch assembly as in claim 7 wherein the upper peripheral flanges have straight shapes extending continuously between the ends of the stamped sheet metal cross tube, and the lower peripheral flanges extending along the ends of the stamped sheet metal cross tube and having inner portions that extend downwardly at the central hitch support section and have lower ends that are spaced from each other.

9. A vehicle hitch assembly as in claim 8 wherein the central hitch support section of the stamped sheet metal cross tube projects downwardly and has a downwardly opening formation located between the lower ends of the inner portions of the lower peripheral flanges, and the hitch ball support being embodied by a hitch receiver tube that is received within the downwardly opening formation of the central hitch support section and is secured thereto by welds.

10. A vehicle hitch assembly as in claim 1 wherein the central hitch support section of the stamped sheet metal cross tube has a downwardly opening formation, and the hitch ball support being embodied by a hitch receiver tube received within the downwardly opening formation of the central hitch support section and secured thereto by welds, and an auxiliary chain connector including a connection plate welded to the central hitch support section.

11. A vehicle hitch assembly as in claim 10 wherein the connection plate has a horizontal portion welded to both the central hitch support section and to the hitch receiver tube, and the connection plate having an inclined portion extending downwardly to the rear from the horizontal portion and having a pair of auxiliary chain connection openings.

12. A vehicle hitch assembly as in claim 1 wherein the spaced peripheral flanges of the pair of stamped sheet metal members of the stamped sheet metal cross tube include front and rear peripheral flanges between which the intermediate portions of the stamped sheet metal members extend respectively projecting upwardly and downwardly away from each other.

13. A vehicle hitch assembly as in claim 12 wherein the front and rear peripheral flanges have straight shapes extending between the ends of the stamped sheet metal cross tube and the central hitch support section.

14. A vehicle hitch assembly as in claim 13 wherein the central hitch support section of the stamped sheet metal cross tube projects rearwardly to provide the hitch ball support which is embodied as a hitch receiver tube.

15. A vehicle hitch assembly as in claim 1 wherein the rear flanges of the pair of stamped sheet metal members have inner ends at the central hitch support section and an auxiliary chain connector including connector holes in the inner ends of the rear flanges.

16. A vehicle hitch assembly for mounting on a vehicle, comprising:
a stamped sheet metal cross tube having an elongated shape that extends laterally with respect to the associated vehicle, and the stamped sheet metal cross tube including a central hitch support section as well as including a pair of laterally extending ends that project laterally away from the central hitch support section for mounting on the vehicle;
the stamped sheet metal cross tube including a pair of stamped sheet metal members of the same construction as each other, said pair of stamped sheet metal members each having an intermediate portion that projects away from the other stamped sheet metal member so the stamped sheet metal cross tube has a hollow construction, and the pair of stamped sheet metal members each having spaced peripheral flanges that are engaged with and secured to the peripheral flanges of the other stamped sheet metal member;
the central hitch support section of the stamped sheet metal cross tube having a hitch ball support for mounting a hitch ball on the hitch assembly; and
a pair of vehicle supports that respectively support the pair of laterally extending ends of the stamped sheet metal cross tube on the vehicle.

17. A vehicle hitch assembly for mounting on a vehicle, comprising:
a stamped sheet metal cross tube having an elongated shape that extends laterally with respect to the associated vehicle, and the stamped sheet metal cross tube including a downwardly projecting central hitch support section as well as including a pair of laterally extending ends that project laterally away from the central hitch support section for mounting on the vehicle;
the stamped sheet metal cross tube including a pair of front and rear stamped sheet metal members of the same construction as each other, said pair of stamped sheet metal members each having an intermediate portion that projects horizontally away from the other stamped sheet metal member so the stamped sheet metal cross tube has a hollow construction, and the pair of stamped sheet metal members each having spaced upper and lower peripheral flanges that are engaged with and secured to the upper and lower peripheral flanges of the other stamped sheet metal member;
the downwardly projecting central hitch support section of the stamped sheet metal cross tube having a hitch ball support embodied by a hitch receiver tube for mounting a hitch ball on the hitch assembly;
an auxiliary chain connector including a connection plate welded to the downwardly projecting central hitch support section and to the hitch receiver tube, and the connection plate including a pair of auxiliary chain connection openings; and
a pair of vehicle supports having openings that respectively receive the pair of laterally extending ends of the stamped sheet metal cross tube to provide support thereof on the vehicle, and welds that secure the laterally extending ends of the stamped sheet metal cross tube to the pair of vehicle supports.

18. A vehicle hitch assembly for mounting on a vehicle, comprising:
a stamped sheet metal cross tube having an elongated shape that extends laterally with respect to the associated vehicle, the stamped sheet metal cross tube including a downwardly projecting central hitch support section having a downwardly opening formation, and the stamped sheet metal cross tube including a pair of laterally extending ends that project laterally away from the central hitch support section for mounting on the vehicle;
the stamped sheet metal cross tube including a pair of stamped sheet metal members of the same construction as each other, said pair of stamped sheet metal members each having an intermediate portion that projects away from the other stamped sheet metal member so the stamped sheet metal cross tube has a hollow construction, and the pair of stamped sheet metal members each having spaced upper and lower peripheral flanges that are engaged with and secured by welds to the upper and lower peripheral flanges of the other stamped sheet metal member, the upper peripheral flanges having straight shapes extending continuously between the ends of the stamped sheet metal cross tube, and the lower peripheral flanges extending along the ends of the stamped sheet metal cross tube and having inner portions that extend downwardly at the central hitch support section and have lower ends that are spaced from each other with the downwardly opening formation of the central hitch support section therebetween;
the central hitch support section of the stamped sheet metal cross tube having a hitch ball support embodied by a hitch receiver tube received within the downwardly opening formation of the central hitch support section between the lower ends of the inner portions of the lower peripheral flanges and having welds thereto so as to mount a hitch ball on the hitch assembly;
an auxiliary chain connector including a connection plate having a horizontal portion welded to both the downwardly projecting central hitch support section and to the hitch receiver tube, and the connection plate having an inclined portion welded to the hitch receiver tube and extending downwardly to the rear from the horizontal portion and having a pair of auxiliary chain connection openings; and
a pair of vehicle supports having openings that respectively receive the pair of laterally extending ends of the stamped sheet metal cross tube to provide support thereof on the vehicle, and welds that secure the laterally extending ends of the stamped sheet metal cross tube to the pair of vehicle supports.

19. A vehicle hitch assembly for mounting on a vehicle, comprising:
a stamped sheet metal cross tube having an elongated shape that extends laterally with respect to the associated vehicle, and the stamped sheet metal cross tube including a rearwardly projecting central hitch support section as well as including a pair of laterally extending ends that project laterally away from the central hitch support section for mounting on the vehicle;
the stamped sheet metal cross tube including a pair of upper and lower stamped sheet metal members of the same construction as each other, said pair of stamped sheet metal members each having an intermediate portion that projects vertically away from the other stamped sheet metal member so the stamped sheet metal cross tube has a hollow construction, and the pair of stamped sheet metal members each having spaced front and rear peripheral flanges that are engaged with and secured to the front and rear peripheral flanges of the other stamped sheet metal member;
the rearwardly projecting central hitch support section of the stamped sheet metal cross tube including a hitch ball support which is embodied by a hitch receiver tube for mounting a hitch ball on the hitch assembly;
an auxiliary chain connector embodied by connector including a connection plate welded holes in inner ends of the rear flanges of the upper and lower stamped sheet metal members; and
a pair of vehicle supports having openings that respectively receive the pair of laterally extending ends of the stamped sheet metal cross tube to provide support thereof on the vehicle, and welds that secure the laterally extending ends of the stamped sheet metal cross tube to the pair of vehicle supports.

20. A vehicle hitch assembly for mounting on a vehicle, comprising:
a stamped sheet metal cross tube having an elongated shape that extends laterally with respect to the associated vehicle, the stamped sheet metal cross tube including a rearwardly projecting central hitch support section, and the stamped sheet metal cross tube including a pair of laterally extending ends that project laterally away from the central hitch support section for mounting on the vehicle;
the stamped sheet metal cross tube including a pair of upper and lower stamped sheet metal members of the same construction as each other, said pair of stamped sheet metal members each having an intermediate portion that projects vertically away from the other stamped sheet metal member so the stamped sheet metal cross tube has a hollow construction, the pair of stamped sheet metal members each having spaced front and rear peripheral flanges that are engaged with and secured by welds to the front and rear peripheral flanges of the other stamped sheet metal member, the front peripheral flanges extending continuously between the ends of the stamped sheet metal cross tube, and the rear peripheral flanges extending along the ends of the stamped sheet metal cross tube and having inner ends at the central hitch support section;
the rearwardly projecting central hitch support section of the stamped sheet metal cross tube including a hitch ball support which is embodied by a hitch receiver tube located between the inner ends of the rear peripheral flanges;
an auxiliary chain connector embodied by connector holes in the inner ends of the rear flanges of the upper and lower stamped sheet metal members; and
a pair of vehicle supports having openings that respectively receive the pair of laterally extending ends of the stamped sheet metal cross tube to provide support thereof on the vehicle, and welds that secure the laterally extending ends of the stamped sheet metal cross tube to the pair of vehicle supports.
